(19) United States
(12) Patent Application Publication
(10) Pub. No.: US 2013/0191613 A1
(43) Pub. Date: Jul. 25, 2013

(54) PROCESSOR CONTROL APPARATUS AND METHOD THEREFOR

(71) Applicant: CANON KABUSHIKI KAISHA, Tokyo (JP)

(72) Inventor: Tetsuya Takahashi, Niigata-shi (JP)

(73) Assignee: CANON KABUSHIKI KAISHA, Tokyo (JP)

(21) Appl. No.: 13/712,889

(22) Filed: Dec. 12, 2012

(30) Foreign Application Priority Data
Jan. 23, 2012 (JP) 2012-011510

(51) Int. Cl. G06F 15/76

(52) U.S. Cl. CPC G06F 15/76
USPC 712/30

(57) ABSTRACT

Whether each of a plurality of processor cores is in a suspend state or operation state is detected. The processor utilization of a processor core of interest in the operation state is acquired. The number of processes assigned to the processor core of interest is obtained. The stop control or startup control of a processor core is performed based on the suspend state or operation state, the processor utilization, and the number of processes.

### BACKGROUND OF THE INVENTION

1. Field of the Invention

The present invention relates to the stop and startup control of a processor core of a multicore processor.

2. Description of the Related Art

Some multicore processors to be embedded have a function of performing the stop and startup control of each processor core (CPU core), and can perform control equivalent to stop and startup control performed on each CPU core in a multiprocessor.

There is a technique that monitors the CPU utilization in a processor by using a system controller, and performs the stop and startup control of each CPU core in accordance with the CPU utilization. This technique performs the stop and startup control of a CPU core based on the CPU utilization alone in a multicore processor environment. Therefore, even a CPU core assigned a large number of processes having low loads is shifted to a suspend state if the CPU utilization decreases to a predetermined amount.

The processes assigned to the CPU core to be shifted to the suspend state are reassigned to another CPU core in an operation state. Consequently, the number of processes of the CPU core to which the processes are reassigned increases, and this may largely increase the overhead of a context switch of the latter CPU core.

Also, a CPU core assigned processes small in number but having high loads sometimes exists. In this case, if the CPU utilization of the CPU core increases to a predetermined amount, a CPU core in the suspend state is shifted to the operation state, and some processes are reassigned to the CPU core shifted to the operation state. However, even when processes having low loads are reassigned to the CPU core shifted to the operation state, the CPU utilization of the CPU core assigned high-load processes does not largely decrease. In addition, if the number of processes requiring processing is small, the processing time does not largely reduce even when the processes are shared by a plurality of CPU cores including a CPU core newly shifted to the operation state.

As described above, when the stop and startup control of a CPU core is performed based on the CPU utilization alone, there is the possibility that the processing efficiency does not largely change and the power consumption of a multicore processor is increased by unnecessary stop and startup control of a CPU core.

### SUMMARY OF THE INVENTION

In one aspect, a control apparatus for controlling a multicore processor which has a plurality of processor cores, the apparatus comprises: a detector configured to detect a suspend state or an operation state of each of the plurality of processor cores; an acquisition section configured to acquire processor utilization of a processor core of interest in the operation state; an obtaining section configured to obtain a number of processes assigned to the processor core of interest; and a controller configured to perform stop control or startup control of a processor core, based on the acquired processor utilization, and the obtained number of processes.

According to the aspect, it is possible to perform efficient stop and startup control of a processor core in a multicore processor.

Further features of the present invention will become apparent from the following description of exemplary embodiments with reference to the attached drawings.

### BRIEF DESCRIPTION OF THE DRAWINGS

FIG. 1 is a block diagram for explaining the arrangement of a control apparatus of an embodiment.

FIG. 2 is a block diagram for explaining the arrangement of an information processing apparatus.

FIG. 3 is a view for explaining the relationship between CPU cores and RUN queues.

FIG. 4 is a flowchart for explaining the stop control of a CPU core.

FIG. 5 is a flowchart for explaining the startup control of a CPU core.

FIG. 6 is a view showing conditions for shifting a CPU core to a suspend state.

FIG. 7 is a view showing conditions for shifting a CPU core to an operation state.

### DESCRIPTION OF THE EMBODIMENTS

The control of a processor of an embodiment according to the present invention will be explained in detail below with reference to the accompanying drawings.

### Arrangement of Control Apparatus

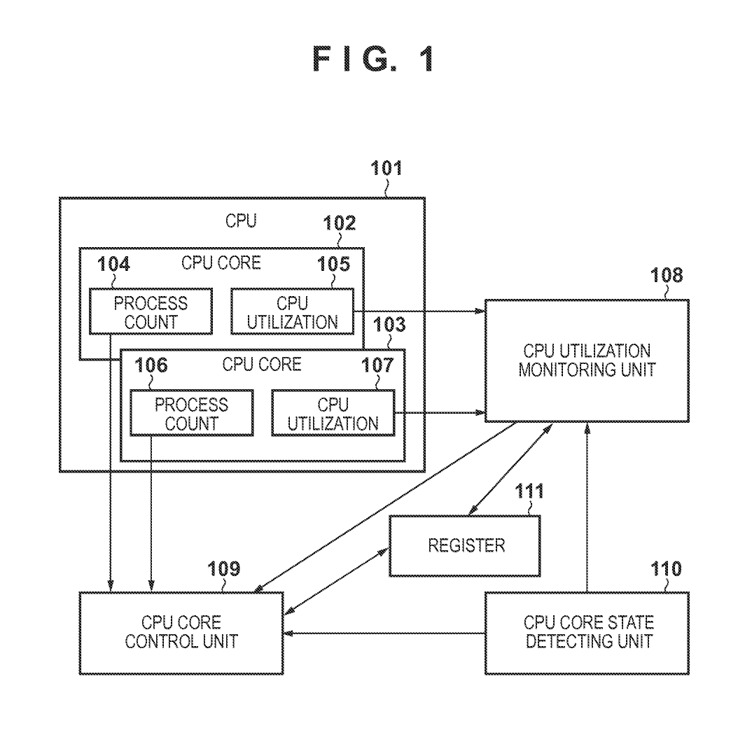

The arrangement of a control apparatus as a processor apparatus of the embodiment will be explained with reference to a block diagram shown in FIG. 1.

A microprocessor (CPU) 101 includes a first processor core (CPU core) 102 and second processor core (CPU core) 103. The CPU core 102 is assigned processes whose number is indicated by a process count 104, and processor utilization 105 indicates the processor utilization (to be referred to as the “CPU utilization” hereinafter) of the CPU core 102. The CPU core 103 is assigned processes whose number is indicated by a process count 106, and CPU utilization 107 indicates the CPU utilization of the CPU core 103. Note that each of the CPU utilizations 105 and 107 indicates the utilization rate of a single CPU core.

A CPU utilization monitoring unit 108 monitors the CPU utilizations 105 and 107 at a predetermined interval. A CPU control unit 109 monitors the process counts 104 and 106, and also performs the stop control and startup control of the CPU cores 102 and 103. A CPU core state detecting unit 110 detects the suspend state and operation state of the CPU cores 102 and 103.

A register 111 holds various threshold values as conditions (to be described later) for shifting to the suspend state and operation state, and can be referred to by the CPU utilization monitoring unit 108 and CPU core control unit 109.

[Arrangement of Information Processing Apparatus]

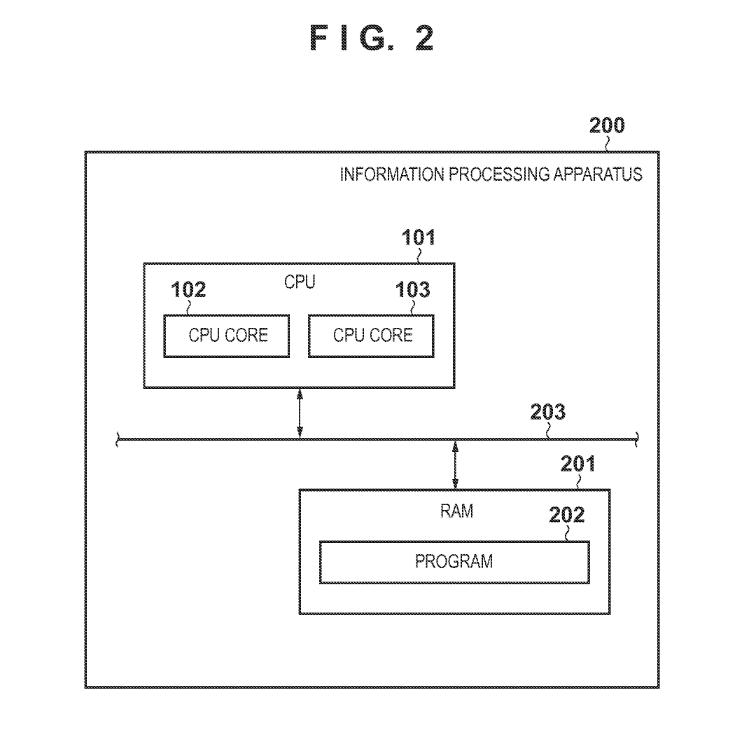

The arrangement of an information processing apparatus will be explained with reference to a block diagram shown in FIG. 2.

An information processing apparatus 200 includes the CPU 101 shown in FIG. 1, and the CPU cores 102 and 103 are connected to a RAM 201 via a CPU bus 203. A program 202 stored in the RAM 201 is executed by the CPU cores 102 and 103 in parallel. That is, when the CPU cores 102 and 103 are in the operation state, the CPU core 102 executes a part of the process of the program 202, and the CPU core 103 executes another part of the program 202. When one CPU core is in the suspend state, the other CPU core executes a part or the whole of the program 202.

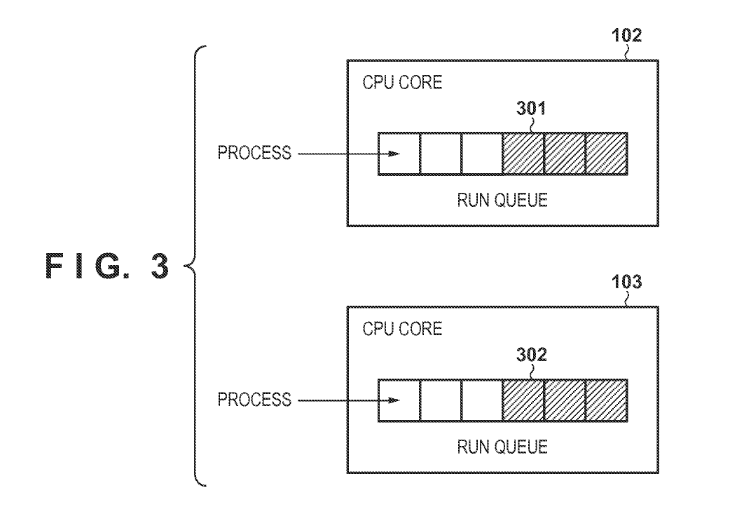

The relationship between the CPU cores and RUN queues will be explained below with reference to FIG. 3. The CPU core 102 has a RUN queue 301, and the CPU core 103 has a RUN queue 302. The CPU core 102 stores assigned processes in the RUN queue 301, and the CPU core 103 stores assigned processes in the RUN queue 302.

Note that the register 111 holding various threshold values as conditions (to be described later) for shifting to the suspend state and operation state can also be assigned to the RAM 201. This facilitates changing each threshold value.

[Stop and Startup Control]

Conditions for Shifting to Suspend State

Whether to shift a CPU core to the suspend state is determined by using a CPU core stop threshold value Rₛₜₒₚth of the CPU utilization monitoring unit 108, and a process stop threshold value Nₛₜₒₚth of the CPU core control unit 109. The conditions for shifting a CPU core to the suspend state are as follows.

(1) CPU utilization Ru of a CPU core is smaller than the CPU core stop threshold value Rₛₜₒₚth,

(2) A process count Np of the CPU core is smaller than the process stop threshold value Nₛₜₒₚth, and

(3) A plurality of CPU cores are in the operation state.

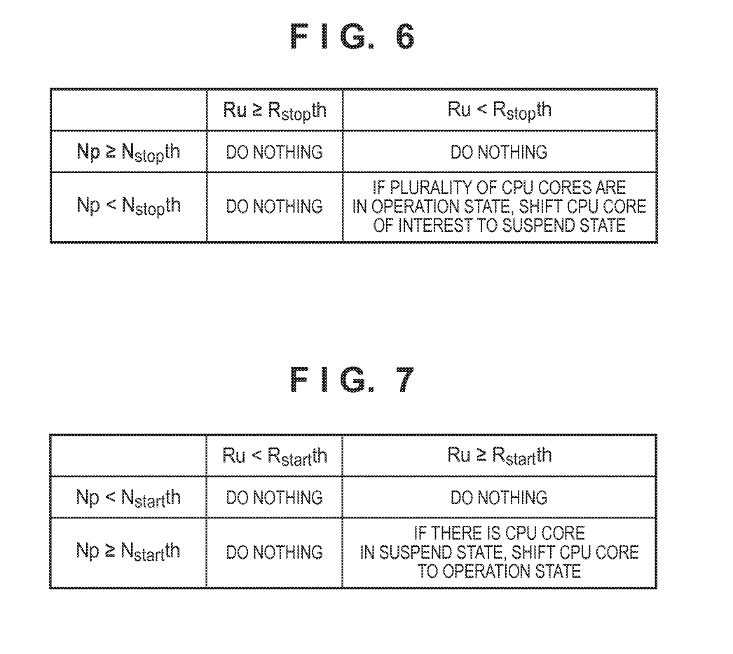

That is, when condition (3) is satisfied, a CPU core meeting conditions (1) and (2) is shifted to the suspend state. If any of these conditions is not satisfied, the stop and startup control of a CPU core is not performed. Accordingly, the conditions for shifting a CPU core to the suspend state are as shown in FIG. 6.

Conditions for Shifting to Operation State

Whether to shift a CPU core to the operation state is determined by using a CPU core startup threshold value Rₛₜₐᵣₜth of the CPU utilization monitoring unit 108, and a process startup threshold value Nₛₜₐᵣₜth of the CPU core control unit 109. The conditions for shifting a CPU core to the operation state are as follows.

(4) The CPU utilization Ru of a CPU core is equal to or larger than the CPU core startup threshold value Rₛₜₐᵣₜth,

(5) The process count Np of the CPU core is equal to or larger than the process startup threshold value Nₛₜₐᵣₜth, and

(6) A CPU core in the suspend state exists.

That is, when a CPU core meeting conditions (4) and (5) exists and condition (6) is satisfied, the CPU core in the suspend state is shifted to the operation state. If any of these conditions is not satisfied, the stop and startup control of a CPU core is not performed. Accordingly, the conditions for shifting a CPU core to the operation state are as shown in FIG. 7.

Stop Control

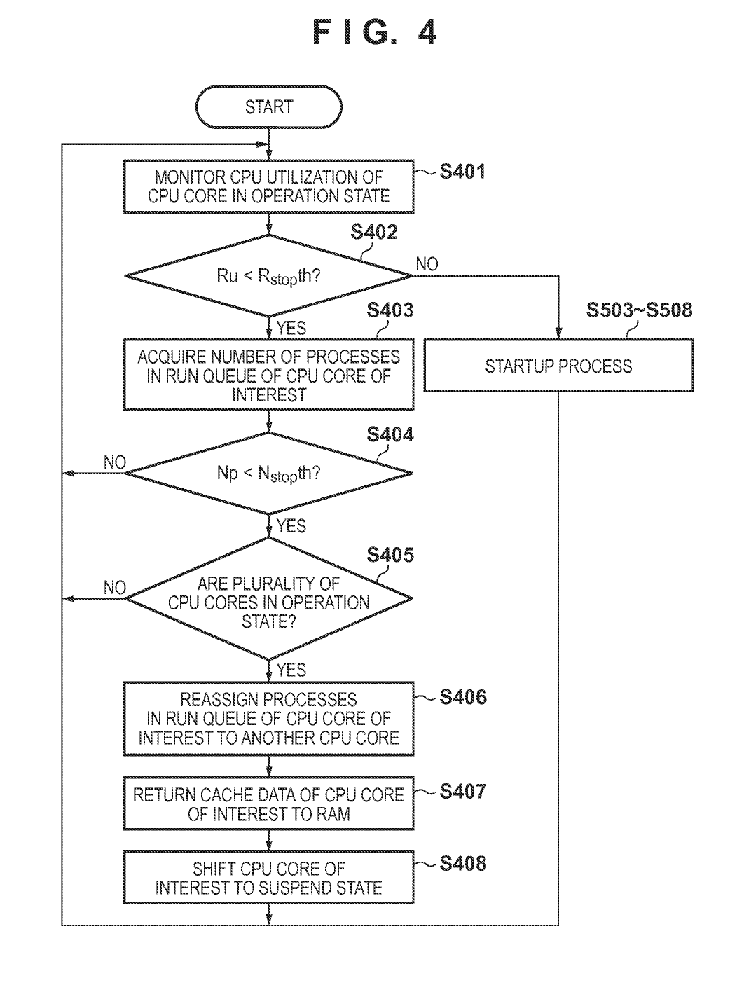

The stop control of a CPU core will be explained below with reference to FIG. 4.

The CPU utilization monitoring unit 108 monitors the CPU utilization of a CPU core in the operation state (step S401), and checks the acquired CPU utilization (step S402).

Processing when the CPU utilization monitoring unit 108 determines that the CPU utilization of the CPU core (to be referred to as a processor core of interest or CPU core of interest hereinafter) whose CPU utilization is acquired is equal to or larger than the CPU core stop threshold value (Ru≧Rₛₜₒₚth) will be explained in “startup control” (to be described later). If it is determined that the CPU utilization is smaller than the CPU core stop threshold value (Ru<Rₛₜₒₚth), the CPU core control unit 109 acquires the number of processes in the RUN queue of the CPU core of interest (step S403), and checks the acquired process count (step S404).

If the CPU core control unit 109 determines that the process count is equal to or larger than the process stop threshold value (Np≧Nₛₜₒₚth), the process returns to step S401. If it is determined that the process count is smaller than the process stop threshold value (Np<Nₛₜₒₚth), the CPU core state detecting unit 110 determines whether a plurality of CPU cores are in the operation state (step S405). If only one CPU core is in the operation state, in other words, if only the CPU core of interest is in the operation state, the process returns to step S401.

If a plurality of CPU cores are in the operation state, the CPU core control unit 109 performs a process of stopping the CPU core of interest. That is, the CPU core control unit 109 reassigns the processes in the RUN queue of the CPU core of interest to another CPU core in the operation state (step S406), returns cache data of the CPU core of interest to the RAM 201 (step S407), and shifts the CPU core of interest to the suspend state (step S408). After that, the process returns to step S401.

As described above, when the number of processes in the RUN queue of the CPU core of interest is equal to or larger than the process stop threshold value, no stop process is performed on the CPU core of interest. Consequently, it is possible to give priority to the processing efficiency by suppressing the overhead of the context switch.

Note that when only one CPU core is in the operation state, no stop process is performed on the CPU core of interest because if the stop process is performed on the CPU core of interest, all CPU cores are shifted to the suspend state, so processing cannot be continued any longer.

Startup Control

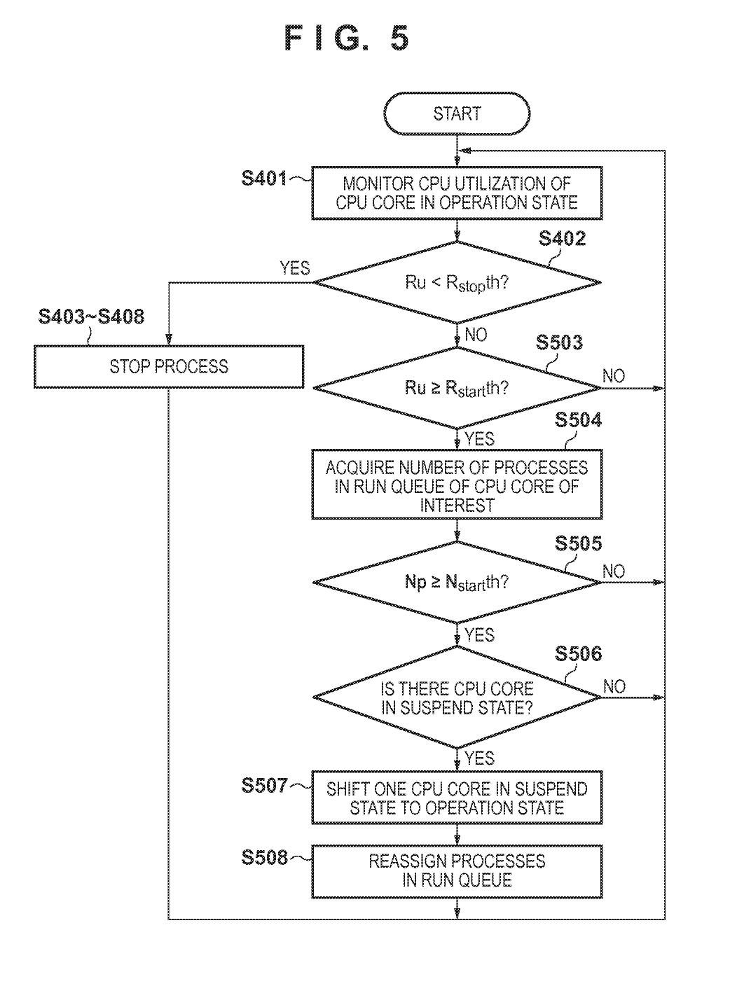

The startup control of a CPU core will be explained below with reference to a flowchart shown in FIG. 5. Note that processes in steps S401 and S402 shown in FIG. 5 are the same as those in steps S401 and S402 shown in FIG. 4, so a detailed explanation thereof will be omitted.

If the CPU utilization monitoring unit 108 determines that the CPU utilization of a CPU core of interest is equal to or larger than the CPU core stop threshold value (Ru≧Rₛₜₒₚth) (step S402), the CPU utilization monitoring unit 108 determines whether this CPU utilization is equal to or larger than the CPU core startup threshold value (step S503).

If the CPU utilization monitoring unit 108 determines that the CPU utilization of the CPU core of interest is smaller than the CPU core startup threshold value (Ru<Rₛₜₐᵣₜth), the process returns to step S401. If it is determined that the CPU utilization is equal to or larger than the CPU core startup threshold value (Ru≧Rₛₜₐᵣₜth), the CPU core control unit 109 acquires the number of processes in the RUN queue of the CPU core of interest (step S504), and checks the acquired process count (step S505).

If the CPU core control unit 109 determines that the process count is smaller than the process startup threshold value (Np<Nₛₜₐᵣₜth), the process returns to step S401. If it is determined that the process count is equal to or larger than the process startup threshold value (Np≧Nₛₜₐᵣₜth), the CPU core state detecting unit 110 determines whether there is a CPU core in the suspend state (step S506). If there is no CPU core in the suspend state, the process returns to step S401.

If there is a CPU core in the suspend state, the CPU core control unit 109 performs a process of starting up the CPU core in the suspend state. That is, the CPU core control unit 109 shifts one CPU core in the suspend state to the operation state (step S507), and reassigns the processes in the RUN queue (step S508). After that, the process returns to step S401. Note that as a CPU core to be shifted to the operation state, a CPU core having, e.g., the smallest (or largest) CPU number is selected from CPU cores in the suspend state.

Note that the reassignment of processes is an operation in which some processes stored in the RUN queue of a CPU core of interest found to have CPU utilization equal to or larger than the CPU core startup threshold value and a process count equal to or larger than the process startup threshold value are moved to the RUN queue of a CPU core shifted to the operation state.

As described above, no CPU core startup process is performed if the number of processes in the RUN queue of a CPU core of interest is smaller than the process startup threshold value. That is, if a CPU core has a large CPU utilization but has a small process count, the processing efficiency does not largely change even when parallel processing is performed by starting up a CPU core in the suspend state. Therefore, the process of starting up the CPU core in the suspend state is not performed. As a consequence, it is possible to prevent the increase in power consumption of a multiprocessor by performing no unnecessary stop and startup control of a CPU core.

### Modification of Embodiment

In the above description, an example in which the CPU utilization monitoring unit 108 having the CPU core stop threshold value Rₛₜₒₚth and CPU core startup threshold value Rₛₜₐᵣₜth checks the CPU utilization has been explained. Likewise, an example in which the CPU core control unit 109 having the process stop threshold value Nₛₜₒₚth and process startup threshold value Nₛₜₐᵣₜth checks the process count has been explained. For example, however, the CPU core control unit 109 may also have all these threshold values and check the CPU utilization acquired and supplied by the CPU utilization monitoring unit 108.

In addition, it is also possible to form an acquisition unit for acquiring the CPU utilization and process count, and cause the CPU core control unit 109 to check the CPU utilization and process count acquired and supplied by the acquisition unit.

Also, the stop and startup control of a multicore processor including two CPU cores has been explained above. However, the present invention is applicable to the stop and startup control of a multicore processor including a plurality of CPU cores, regardless of whether the number of CPU cores is, e.g., four or eight.

Furthermore, in the above description, an example in which the hardware of the control apparatus including a multicore processor performs the stop and startup control has been explained. However, the stop and startup control can also be performed by a program loaded into the RAM 201.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-011510, filed Jan. 23, 2012, which is hereby incorporated by reference herein in its entirety.

What is claimed is:

1. A control apparatus for controlling a multicore processor which has a plurality of processor cores, the apparatus comprising:
a detector configured to detect a suspend state or an operation state of each of the plurality of processor cores;
an acquisition section configured to acquire processor utilization of a processor core of interest in the operation state;
an obtaining section configured to obtain a number of processes assigned to the processor core of interest; and
a controller configured to perform stop control or startup control of a processor core, based on the acquired processor utilization and the obtained number of processes.

2. The apparatus according to claim 1, further comprising a memory which holds a processor core stop threshold value and a process stop threshold value as conditions for shifting a processor core in the operation state to the suspend state,
wherein, in a case that there are a plurality of processor cores each of which has the processor utilization smaller than the processor core stop threshold value, has the number of processes smaller than the process stop threshold value, and is in the operation state, the controller performs stop control on the processor core of interest.

3. The apparatus according to claim 2, wherein, in a case that the number of processes assigned to the processor core of interest is not less than the process stop threshold value, the controller performs no stop control on the processor core of interest.

4. The apparatus according to claim 1, further comprising a memory which holds a processor core startup threshold value and a process startup threshold value as conditions for shifting a processor core in the suspend state to the operation state,
wherein, in a case that there is a processor core which has the processor utilization not less than the processor core startup threshold value, has the number of processes not less than the process startup threshold value, and is in the suspend state, the controller performs startup control on the processor core in the suspend state.

5. The apparatus according to claim 4, wherein, in a case that the number of processes assigned to the processor core of interest is smaller than the process startup threshold value, the controller performs no startup control.

6. A control method of controlling a multicore processor which has a plurality of processor cores, the method comprising:
using a control processor to perform the steps of:
detecting a suspend state or an operation state of each of the plurality of processor cores;
acquiring processor utilization of a processor core of interest in the operation state;
obtaining a number of processes assigned to the processor core of interest; and
performing stop control or startup control of a processor core, based on the acquired processor utilization and the obtained number of processes.

7. A non-transitory computer readable medium storing a computer program for causing a control processor to perform a control method of controlling a multicore processor which has a plurality of processor cores, the method comprising the steps of:
detecting a suspend state or an operation state of each of the plurality of processor cores;
acquiring processor utilization of a processor core of interest in the operation state;
obtaining a number of processes assigned to the processor core of interest; and
performing stop control or startup control of a processor core, based on the acquired processor utilization and the obtained number of processes.
